(19) United States
(12) Patent Application Publication
(10) Pub. No.: US 2005/0218464 A1
(43) Pub. Date: Oct. 6, 2005

(54) Biochemical ultrasensitive charge sensing

(76) Inventor: James W. Holm-Kennedy, Honolulu, HI (US)

Correspondence Address: JAMES C. WRAY, 1493 CHAIN BRIDGE ROAD, SUITE 300, MCLEAN, VA, 22101, US

(21) Appl. No.: 11/083,108

(22) Filed: Mar. 18, 2005

Related U.S. Application Data
(60) Provisional application No. 60/554,610, filed on Mar. 18, 2004.
(60) Provisional application No. 60/554,612, filed on Mar. 18, 2004.
(60) Provisional application No. 60/554,616, filed on Mar. 18, 2004.

(51) Int. Cl. G01N 31/00

(52) U.S. Cl. 257/414; 422/82.01; 436/149; 435/287.2

(57) ABSTRACT

Chemical sensors for detecting chemicals are provided using surface and bulk selective chemical reactions. Large charge complexes are bound to the bound target and provide ultrasensitive sensing detection of the original target. In particular embodiments, the sensing device is affected by a change in the resistance of some key part of the device. In certain embodiments, the invention employs beads and other systems to provide a significantly enhanced sensor detection signal. In other embodiments, the invention employs chemical reactions with a pre-selected surface integrated with a suitable semiconductor sensor devices where material coats the top active sensing region of a sensor, and a reaction results in a new compound.

This application claims the benefit of U.S. Provisional Application No. 60/554,610, filed Mar. 18, 2004, U.S. Provisional Application No. 60/554,612, filed Mar. 18, 2004, and U.S. Provisional Application No. 60/554,616, filed Mar. 18, 2004, which are hereby incorporated by reference in their entirety.

### BACKGROUND OF THE INVENTION

Biosensors have been and are being developed to detect, identify and quantify various biochemicals, ranging from proteins to toxins to RNA to c-DNA to oligos and to disease agents such as viruses, bacteria, spores and Prions. This list is by way of example, and is not intended to be complete. Some biosensors sense charge on the molecule. Many biochemicals carry a net charge. Electrophoresis methods and various blots exploit molecule net charge to affect physical separation of such molecules.

There is a significant problem with existing techniques such as electrophoresis and the various blots. These sensors are not specific in identifying the molecules in question unless significant post processing and labeling is employed. Further, a very large quantity of the tested biochemical is required for electrophoresis detection methodologies.

In many instances the number of molecules available for detection is very small and may be below the sensitivity threshold of the sensor, or may be problematic with respect to sensitivity. For example, some plasma proteins are of very low concentration. Toxins such as Botulinum toxin are notoriously hard to detect at lethal thresholds because of their very low lethal and sub-lethal, but still dangerous, concentrations. Mass spectroscopy requires a large number of molecules in order to achieve adequate detection sensitivity.

In the case of c-DNA and RNA sensing, the number of base pairs present may be low for adequate detection and determination of which one is trying to specifically identify. This is possible if, for example, only a few bacteria are present or the RNA is of low concentration because of function. Virus RNA may be of low density for samples monitoring air. Only a small portion of the RNA may provide the definitive identification signature. Overall this can lead to a relatively small amount of RNA or DNA actually involved in the definitive detection process, if only few bacterial or viruses are present.

In the case of proteins, the target molecule concentration may be very low in the sample. For example, with Prions (mad cow disease), if a fluid sample is taken from an animal's blood, the target protein concentration may be very low. With a rapid infection of humans, animals or plants with disease, the initial signature indicators may be present in only very small concentrations. For the very early stages of cancer, when one wishes to identify disease presence, definitive indicators may be present in only very small concentrations. An example includes the four or so proteins indicative of ovarian cancer. Where only small concentrations of target molecules are available, mass action effects can result in the bound target concentration being very low. A small percentage of the actual receptors, specific antibodies, available for bonding results in a very small detection signal, for example, as is the case of a lethal concentration of botulinum toxin. At the very earliest onset of disease, the density of indicative proteins, viruses, antibodies and bacteria may be very low, requiring putting a very high sensitivity burden on the sensing approach.

Sensors for the detection of target molecules using charge have been reported. The most commonly used to date are those using electrophoreses methods, such as the various blots. Semiconductor charge sensors have long been highly prized due to their compatibility with integrated circuits and attendant low cost manufacturing processes. An example is the ImmunoFET that uses a conventional MOSFET, absent a metal gate, and employing a reference electrode in solution.

Sensors sense a change in charge or chemical potential as a result of a chemical attachment to the gate region of the devices. Needs exist for sensitive sensors that can sense very low concentrations. Need exist for sensitive sensors that are IC compatible, especially CMOS compatible, and which overcome the obstacles reported for prior semiconductor based chemical sensors.

Contamination and pollution in water, air and foodstuff is a continuing threat to public health. Water contaminated with Pb, Hg, Dioxin, or other hazardous chemical substances is problematic. Air may be contaminated with hazardous chemicals, of which OSHA has a long list, either in the general environment, the home, the industrial workplace or the chemical factory. Food contamination is likewise problematic for public heath. The chemicals in question may be inorganic (such as Pb and Hg), organic (such as organic solvents) or biochemical such as viruses, bacteria, toxins and hazardous proteins.

Additional environmental threats arise from potential chemical use by terrorists. Such threats include the well-known toxins such as botulinum toxin and ricin, as well as many others. Another threat is that of explosives intentionally (such as bombs introduced by terrorists) or unintentionally (such as antipersonnel mines) found in some location.

There is a need for an electronic sensor that can detect such public health risk chemicals in water, air and foodstuffs. In general, such requirements include biosensors that may incorporate such specific chemical binding means as oligos, proteins and antibodies. These application sensors are discussed in a separate disclosure.

### SUMMARY OF THE INVENTION

The invention provides chemical sensors for detecting environmental chemicals using surface and bulk selective chemical reactions.

Applying additional charge to the sensed molecule can provide additional detection signal. It is this need that is the object of the invention described herein. Such charge may be supplied in several non-obvious ways as described below. FIGS. 1 and 2 show a general schematic of a gate-semiconductor structure, by way of example, where the charge on the gate influences the underlying electron transport. The large triangle symbolically represents the attached charge enhancement.

Such attachment also may be used to enhance contact potential (chemical potential) changes on the gate arising from the attachment process. Additionally, the attachment may be used to provide additional confirmatory information on the specific target detection. These two applications will be discussed elsewhere.

FIGS. 1 and 2 show a basic sensing device comprising an underlying conductive region that is influenced by attached gate materials or chemicals. The underlying conductive region, such as can be created in a semiconductor or other conductive media such as a nanotube, functions in this example as a simple resistor that may be used as is or may be incorporated into a more complex semiconductor device such as an FET, BJT, DCBD structure or other semiconductor device or combination of devices, by way of example. Any charges that attach to the sensor active region affect the density of conducting charge in the resistive region, thus changing the resistance of the conductive region through electric field influences. A measure of the resistor's resistance or conductance C change provides a measure of the attached charge to the top region “A” above the conducting region in FIG. 2. The top layer, gate A in FIG. 2, is prepared to provide attachment of a receptor chemical. Here the term receptor is intended in a very general sense to represent a chemical that selectively binds to some other target chemical. Receptors specific to a target molecule or molecules are attached to the attachment region A in FIG. 1. These receptors are then suitable for binding to the specific target species if the target species are present. Typically, such receptors, by way of example, proteins, antibodies or oligos, and biochemical targets are charged and provide a signal output of the charge sensor indicating that the target and receptor are present and how many of the targets are attached.

Additional chemicals, large triangles in FIG. 2, may be exposed to the bound targets, small triangles in FIG. 2, to provide both confirmation and also to increase the signal output. The larger triangle in FIG. 2 represents such a secondary attachment, which carries charge and/or chemical potential. A simple example is a sandwich antibody binding. However, it is possible to do much better than a simple antibody sandwich to provide additional charge attachment to the bound target; the larger the charge that attaches to the already bound target, the larger the signal enhancement.

In the present invention it is possible to bind very large charge complexes to the bound target (e.g., molecule or particle) and in this manner to provide ultrasensitive sensing detection of the original target.

The invention includes a molecule, molecular complex, particle or other structure that is attached to the target molecule (either bound to the sensor or to be bound to the sensors, FIGS. 1 and 2). Such molecules may be any chemical or particle that has charge. Attractive candidates for such additional amplifying charge attachment and thus sensor signal amplification include beads of a wide variety, some of which are charged, detergents, proteins, nucleotides, proteins, antibodies, receptors (e.g., antibodies) and combinations of all of these, by way of example.

In particular embodiments, the sensing device may be affected by a change in the resistance of some key part of the device, C in FIG. 2. One example is an FET. Another is a DCBD. The DCBD is a distributed channel bipolar device invented by the present inventor Dr. James Holm-Kennedy. Still another is a conducting or semi-conducting nanotube such as a carbon nanotube. A DNA molecule may be used and proteins, RNA or other compounds linked to the DNA molecule.

There are two general approaches to the charge amplification schemes:

In one approach, the sensor, prepared with a specific targeting receptor, is attached to the surface of the sensors, e.g., the gate layer shown in FIG. 2. Subsequently, other chemical combinations are introduced that have at least one component that will bind to the bound specific target already bound to the sensor surface.

In the second approach, the target species is mixed with a combination of specific chemical systems and particles and binds to those first, before binding to the sensor gate. Then the mix is exposed to the surface of the sensor, and portions of the already bound targets in solution bind to the gate surface, providing the sensor output detection signal. The charge amplification attachment occurs before binding to the sensor surface. Examples of such binding which provide added charge attachment are oligonucleotides and molecules, e.g., as with an antibody sandwich. Such systems can then bind to a receptor already attached to the surface of the sensor.

A wide range of combinations can be used. Particles such as nano particles or beads of polymer, metal, magnetic, coated and others may be used to bring large quantities of charge to the sensor surface through at least one binding event.

Gobs of material may be attached such as a gob of DNA, chroma cell material, proteins, or a gob of nanotube materials such as nanotubes fabricated from carbon or other chemicals.

There are many manufacturers of micro beads that are commonly used in the biochemical industries. These beads are often coated with a material that enhances the attachment of biochemicals of interest. The beads may be metal, polymer, semiconductor (such as Si or GaAs), or may be fabricated of other materials, and may include more than one material in a single bead. Such beads are routinely used to bind to proteins and nucleotide chemicals such as DNA, c-DNA, RNA, oligos, antibodies and other chemicals. Some beads have a polymer coated surface. Some beads carry a net charge on their own.

By attaching charged chemicals or particles to the beads, the beads are used as large charge suppliers that can, when attaching to the surface of a charge sensing device, deliver a substantial additional net charge to the gate, as shown in FIG. 2. This increases the sensor's signal output significantly. The signal inducing attached charge is amplified. By incorporating a specific binding chemical together with other chemicals on the surface of the bead, the bead is made to attach to the surface of the sensing devices. A significant additional charge is attached to the surface of the charge sensor. Beads or other particles are used to provide increased sensitivity of the sensor for detecting and identifying a particular target.

This charge amplification is particularly important where the original target molecule is of low density, has low or no charge, and where, for example, binding to the receptors on the surface of the sensor is only partial. Some of the receptors are not bound. For very low concentrations of target chemicals, only a very small fraction of the receptors may be found. By way of example, for lethal concentrations of Botulinum toxin, only about 1 in 3000 antibodies are bound. Thus, while the original signal for the only sparsely bound target chemicals may be weak, the attachment of particles with substantial charge offsets and overcomes the problem of weak signals arising from limited binding events, and ultimately provides a large net charge for each target-binding event, and provides easy detection and identification of the original target.

Several illustrative examples are provided in FIGS. 1-7.

The current invention employs the concept of chemical reaction with a pre-selected surface integrated with a suitable semiconductor sensor devices as schematically represented in FIGS. 8A, B, C and D, where material M coats the top active sensing region of a sensor, and said reaction results in a new compound R. Such a material M may combine with a chemical in proximity to create a new compound or an adsorbed layer. An example is iron oxide. A sensor is coated with Fe. Oxidation creates a new compound on the surface of the Fe and ultimately throughout the Fe layer. Other forms of corrosion, i.e. chemical alteration by environmentally encountered substances, may likewise occur. The sensor acts as both a chemical detector and a corrosion monitor/sensor. The reacting chemical to be detected and quantified may be an organic or inorganic chemical. Such targets include corrosive compounds as well as compounds such as the vapor from an explosive. By choosing a selective compound material M that reacts, for example, with the vapor of an explosive to form a layer R, one can detect the explosive. The reaction creates a monolayer, a fraction of a monolayer or may permeate or alter the material layer M.

The material layer M may be an elemental material, an organic material, a biochemical material, a polymer material or other material. The material in the environment that reacts with material M may be elemental (such as Pb), organic (such as an insecticide), biochemical (such as a protein or toxin), a spore, a nerve agent, an explosive compound's vapor, or a combination of agents, by way of example.

In addition to polymer, biochemical, compound or elemental material coatings, membranes may also be adhered to the surface. Such membranes can react with chemicals present as well as transmit chemicals to an underlying surface.

The invention includes a semiconductor conducting region integrated with various semiconductor device structures such as the one shown in FIGS. 8A-D, by way of example. In FIG. 8D, a conductive channel is connected to two ohmic contact regions termed a Source S and a Drain D) and covered by a protective insulating region in one embodiment of the sensors. Alternatively, the conductive region may be coated with a material M directly, as shown in FIG. 8B, and the altered material that is the reaction product R with some environmental chemical is formed. In both cases, the new material R creates a new chemical potential (Fermi Energy) that results in a new contact potential influencing the underlying conductive region.

The reactant R may be a thick coating (such as iron oxide) or a monolayer, or a fraction of a monolayer. The degree of coverage of the monolayer provides a signal via the change in the underlying conductor C, as shown in FIG. 8A, B, C and D, which scales as the amount of surface coverage.

By way of example, FIG. 8E shows the I-V characteristics of a device having a conductive region isolated from a bulk semiconductor (Si) by a back PN junction. The compound R influences the top portion of the conductive region C. The change in chemical potential is detected by monitoring the IV characteristics of the particular electronic device, which incorporates the conductive region C as shown in FIG. 8D). The change in the current characteristics indicated in FIG. 8E arising from the R material created by the environmental agent may be an increase or decrease, depending on the details of the chemical potential.

Similar changes occur when charge is associated with the new reactant R.

Design of the device for the maximum sensitivity to a contact potential change may include the use of a very thin insulation region I. Other design features may be selected to maximize the sensitivity or affect a pre-selected sensitivity features such as sensitivity range through various design considerations that are suitable for the device structure selected for sensing applications.

Capacitive sensing is also explained. Measuring capacitance may be used to monitor the devices, such as illustrated in FIGS. 8A, B, C and D. For example, in FIGS. 8A and B, a change in material M to material R creates a modification in the contact potential of the devices that alters the amount of depletion in the underlying conductive region C or underlying substrate region S. Such change in capacitance may be monitored by direct measurement using instruments, or may be, by way of example, made to transduce to another output parameter such as oscillator frequency where the capacitance is integrated into an oscillator such as a relaxation oscillator.

In general terms, applications include, but are not limited to detection and quantification of an environment chemical in air, water or incorporated into a food supply. Specific applications, by way of example, but not limited to these examples, include the detection of, or alteration of: corrosion characterization, characterizing chemical coatings (such as for protection), detection of target chemicals (such as explosive vapors, insecticides, corrosive chemicals, Pb, Hg, and many others, organic solvents, inorganic materials in general, hazardous compounds or elements, insecticides (and nerve gas), biochemical materials, polymers, gases, fluids, or coatings.

For example, using the invention, one can characterize the quality of a coating for protection against corrosion, such as in seawater. Alternatively, one can use the device to detect the presence of a compound, such as explosives or insecticides. Still another application is to measure the contact potential of materials used in the integrated circuit industry in order to integrate such information into the design of the integrated circuit. For example, Au and Al have different influences. Other more exotic materials have different influences. By way of further example, the top material region may comprise a collection of nano tubes of carbon or some other material. Many other applications will be obvious to those of skill in the chemistry art upon reading this disclosure or hearing a description equivalent to this disclosure or a part of this disclosure.

The invention has many application regimes such a monitoring of water quality, air quality and inspecting for explosives at airports.

This invention includes multiple applications CMOS compatible sensors, distributed channel bipolar devices (DCBDs), biosensors, force sensors, magnetic sensors and optical sensors.

These and further and other objects and features of the invention are apparent in the disclosure, which includes the above and ongoing written specification, with the claims and the drawings.

### BRIEF DESCRIPTION OF THE DRAWINGS

FIG. 1 is a schematic representation of a charge sensing device.

FIG. 2 shows a generic semiconductor charge ultrasensitive sensing device.

FIG. 3A represents the rolling circle DNA amplification method used in biochemistry.

FIG. 3B represents attachment of DNA.

FIG. 3C represents attachment of various types of receptors.

FIG. 4 illustrates a different use of the beads.

FIG. 5 shows a bead that, by way of example, binds to an antigen already bound to an antibody locked onto the gate surface of the sensor, shown in FIG. 1.

FIG. 6A shows a different bead/chemical configuration.

FIG. 6B shows bead charge amplification means.

FIG. 7 shows a nucleotide charge amplifying system.

FIG. 8A shows a conducting region as part of an underlying substrate B.

FIG. 8B shows the material M reacting with a chemical to form a compound R.

FIG. 8C shows a system where the reaction of the chemical with material M causes only a partial coating of material M with the reactant material R.

FIG. 8D shows a semiconductor sensor example.

FIG. 8E shows a current characteristic for the device of FIG. 8D.

### DETAILED DESCRIPTION OF THE PREFERRED EMBODIMENTS

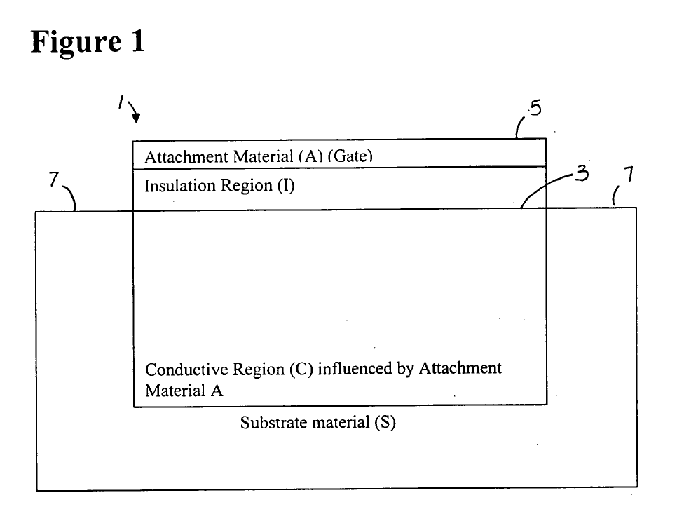

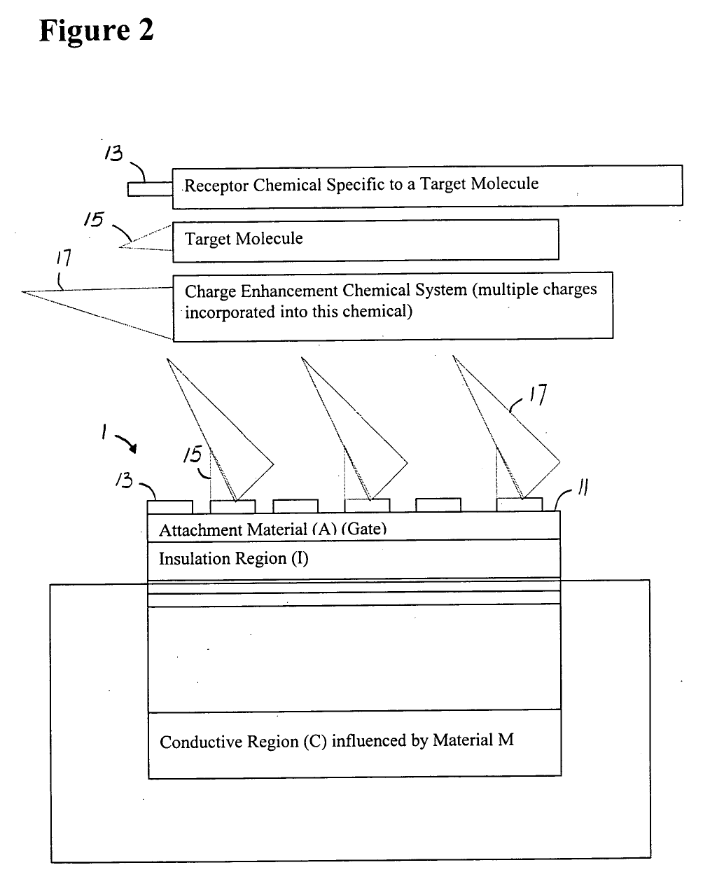

FIGS. 1 and 2 show the general principle of the present invention. FIG. 1 is a schematic representation of a charge sensing device 1. A substrate material S has an insulation region I coated on a surface portion 3. An attachment material A, which forms a gate 5 is coated on the insulation region. The attachment material A influences conductive region C. Contacts 7 are provided on the substrate S at opposite portions. A conducting region is located beneath a gate-influencing region where the charge on the gate affects a conducting C region of the charge sensing device.

FIG. 2 shows a generic semiconductor charge ultrasensitive sensing device 1. In this figure, only a portion of the sensor affected by a gate charge or potential change changes the underlying conductive region C. The device of FIG. 1 is coated with a material 11 to which chemicals 13 are attached, which are in turn specific binders to other molecules 15, such as an antibody binding to an antigen, or an oligo binding to a c-DNA or RNA molecule. After initial detection of the target molecule 15 (small triangle), the system is exposed to a second set of binding chemicals 17 that are made to carry large amounts of charge (large triangle) that find the target. The large amount of additional charge thus amplifies the electronic signal sensed by the sensors 1. That is, the large additional charge provides a large change in the sensor behavior and output signal.

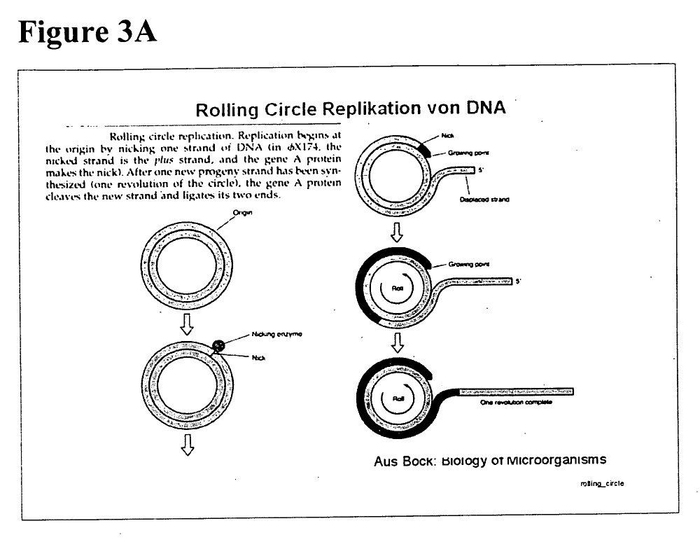

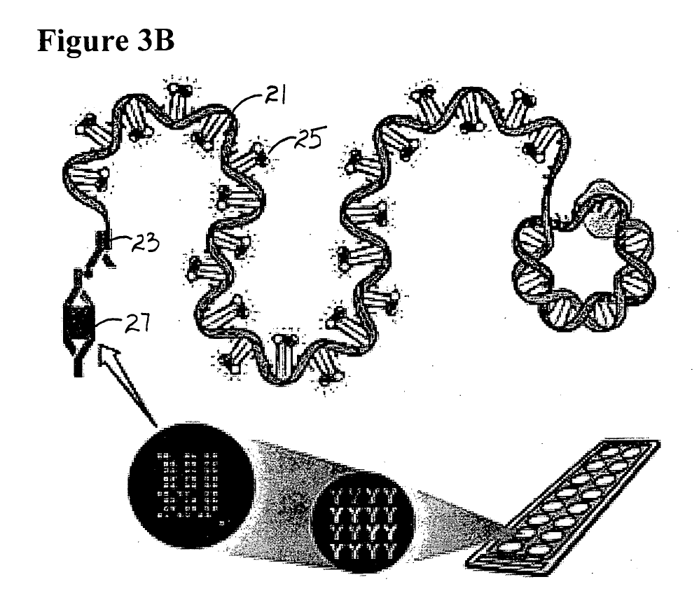

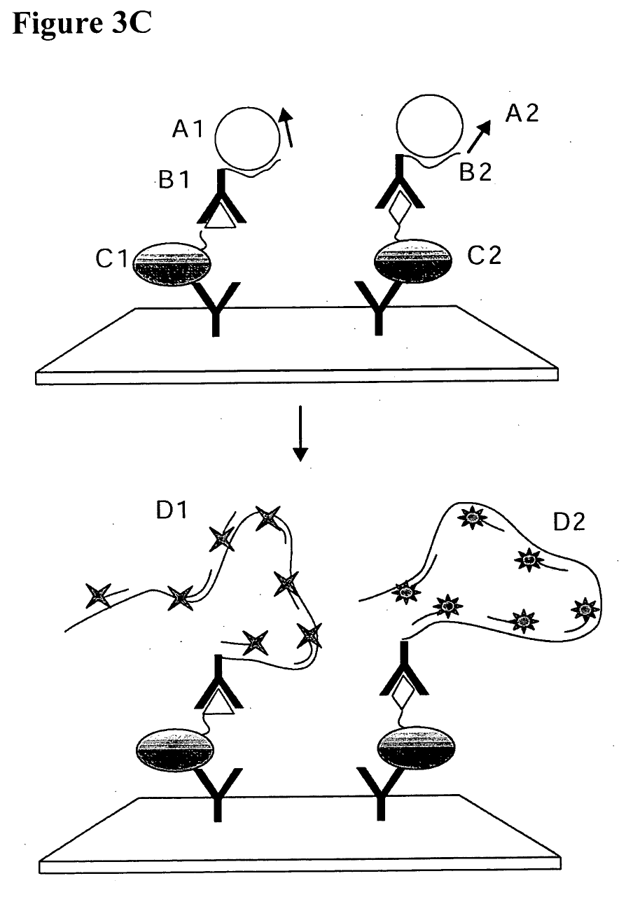

FIG. 3A represents the rolling circle DNA amplification method used in biochemistry. The rolling circle amplification mechanism is incorporated to provide a large strand of charged DNA attached to an antibody, for example. The rolling circle amplification technique can be made to create a long strand of DNA 21 attached to another molecule such as an antibody 23. By increasing the DNA strand length, the number of charges 25 on the DNA is increased. Thus, by way of example, an antibody with an attached rolling circle DNA can be attached in a sandwich form to an antigen 27 already detected. The DNA amplification provides a large amount of additional charge 25 to the sandwich, thus increasing the influence on the detector 1 and the detector's output signal. After attachment the antibody then binds to the already bound target on the gate in the sandwich approach. The objective is to use the attached DNA net charge to provide enhanced charge coating of the sensor gate, as shown in FIG. 1. This use of rolling circle DNA amplification is different fundamentally from that of the usual application that uses florescence for a sensing method. The current invention instead uses charge. The rolling circle DNA amplification scheme can be attached to particles other than antibodies, and this too is included in the scope invention. FIG. 3B represents attachment of DNA. FIG. 3C represents attachment of various types of receptors.

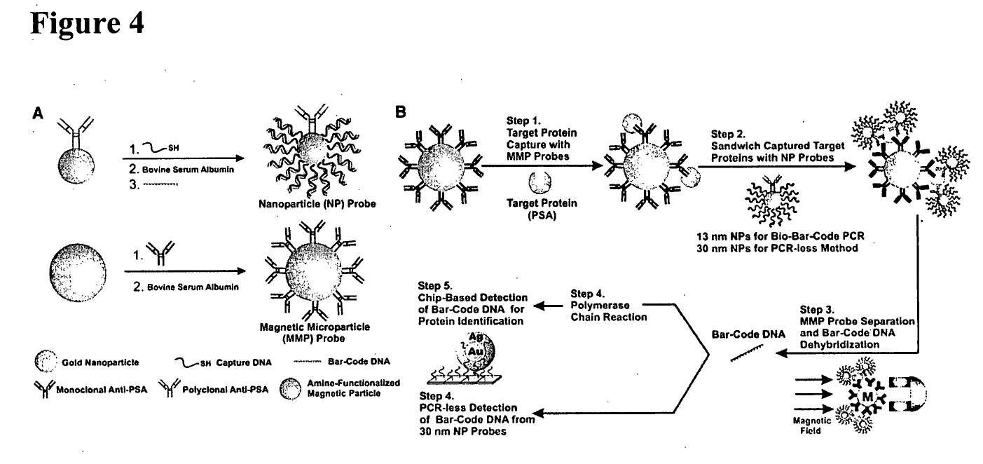

FIG. 4 illustrates a different use of the beads as found in the literature. The system of FIG. 4 uses a refining technique that employs magnetic beads and the recovery of said magnetic beads with a pre-selected target. In the present invention, the concept is to detect the charges on DNA or oligonucleotides and is non obvious to others that use the method for other applications. The applications used herein use beads with multiple oligonucliotides, c-DNA, antibodies, proteins or other charge molecules attached to the beads, with some receptor on the bead being suitable for binding to the target molecule that has attached to the charge sensing device. To reduce contact potential effects arising from metals plastic beads are preferred, but any bead that has such attachments can be used.

A bio-bar code assay method is described in the following example. “A” is probe design and preparation. “B” is PSA detection and bar code DNA amplification and identification. In a typical PSA-detection experiment, an aqueous dispersion of MMP probes functionalized with mAbs to PSA (50 μl of 3 mg/ml magnetic probe solution) is mixed with an aqueous solution of free PSA (10 μl of PSA) and stirred at 37° C. for 30 min (Step 1). A 1.5-ml tube containing the assay solution is placed in a micro-centrifuge tube separator at room temperature. After 15 s, the MMP-PSA hybrids are concentrated on the wall of the tube. The supernatant, solution of unbound PSA molecules, is removed, and the MMPs are re-suspended in 50 μl of 0.1 M phosphate-buffered saline (PBS) (repeated twice). The NP probes (for 13-nm NP probes, 50 μl at 1 nM; for 30-nm NP probes, 50 μl at 200 pM), functionalized with polyclonal Abs to PSA and hybridized bar-code DNA strands, are then added to the assay solution. The NPs react with the PSA immobilized on the MMPs and provide DNA strands for signal amplification and protein identification (Step 2). This solution is vigorously stirred at 37° C. for 30 min. The MMPs are then washed with 0.1 M PBS with a magnetic separator to isolate the magnetic particles. This step is repeated four times, each time for 1 min, to remove everything but the MMPs, along with the PSA-bound NP probes. After the final wash step, the MMP probes are re-suspended in NANO pure water (50 μl) for 2 min to dehybridize bar code DNA strands from the nanoparticle probe surface. Dehybridized bar code DNA is then easily separated and collected from the probes with the use of the magnetic separator (Step 3). For bar code DNA amplification (Step 4), isolated bar code DNA is added to a PCR reaction mixture (20-μl final volume) containing the appropriate primers, and the solution is then thermally cycled (20). The bar code DNA amplicon is stained with ethidium bromide and mixed with gel-loading dye (20). Gel electrophoresis or scanometric DNA detection (24) is then performed to determine whether amplification has taken place. Primer amplification is ruled out with appropriate control experiments (20). Notice that the number of bound NP probes for each PSA is unknown and will depend upon target protein concentration.

In the present invention, an approach is used by incorporating a similar general product generating system with binding antibodies and a product with the oligonucleotides attached to the beads. In the present invention, the latter beads are then subsequently being bound instead to the surface of the sensor. For the current invention, one uses a bead preparation method with the beads modified to bind the beads with heavy nucleotide attachment to the sensor and thereby to add the significant charge of the oligo nucleotides on the bead to the net charge on the sensor gate, shown in FIG. 1. Compounding of the attached oligo coated beads attached to the antibody coated bead can then be attached to the surface bound target. By way of example, an antigen bound to the surface may bind to an antibody attached to the conglomerating bead. This attaches the entire bead complex and collection to the sensor gate.

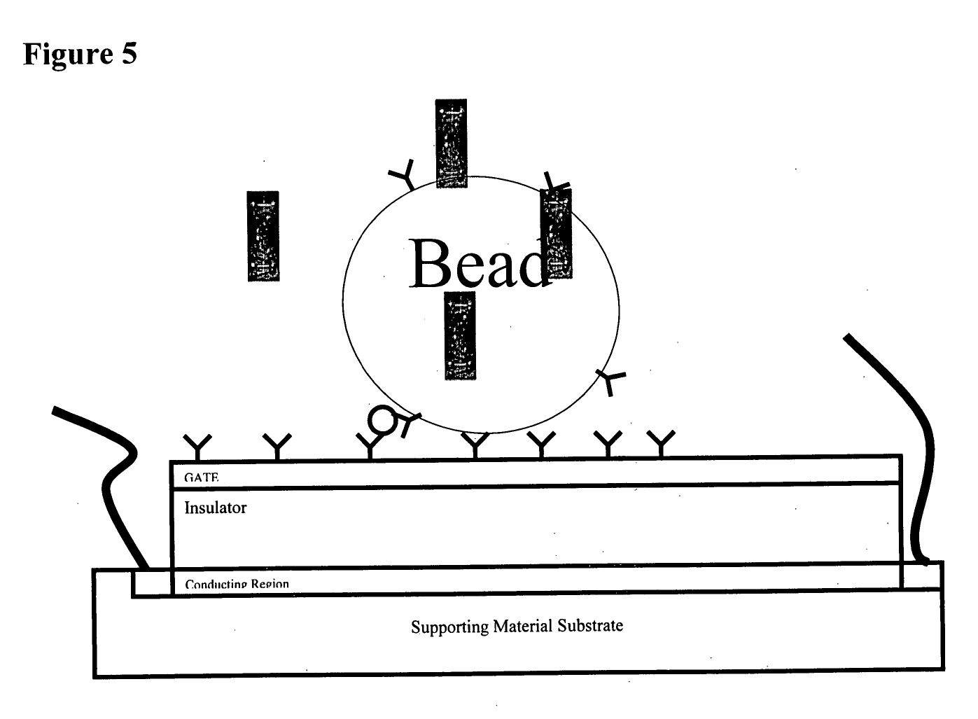

FIG. 5 shows a bead that, by way of example, binds to an antigen already bound to an antibody locked onto the gate surface of the sensor, shown in FIG. 1. FIG. 5 shows a charge application. A bead has antibodies attached, by way of example, where the antibodies are specific to a particular antigen already bound to the sensor gate. In this example, the bead has additionally lengths of DNA or oligonucleotides attached to it. These carry substantial charge. Charge is associated with both the oligo nucleotides and the antibodies. A change in pH can be used to change the amount of charge involved. A mix of nucleotide molecules added to the bead adds charge and antibodies are attached to the bead surface. The antibody then forms a sandwich, binding to the surface bound antigen and thereby attaching the bead and its large net charge to the sensor surface. In an alternative example, the bead's antibody may be replaced with an oligo that binds to a specific c-DNA, RNA or oligo target that is already bound to the sensor gate surface.

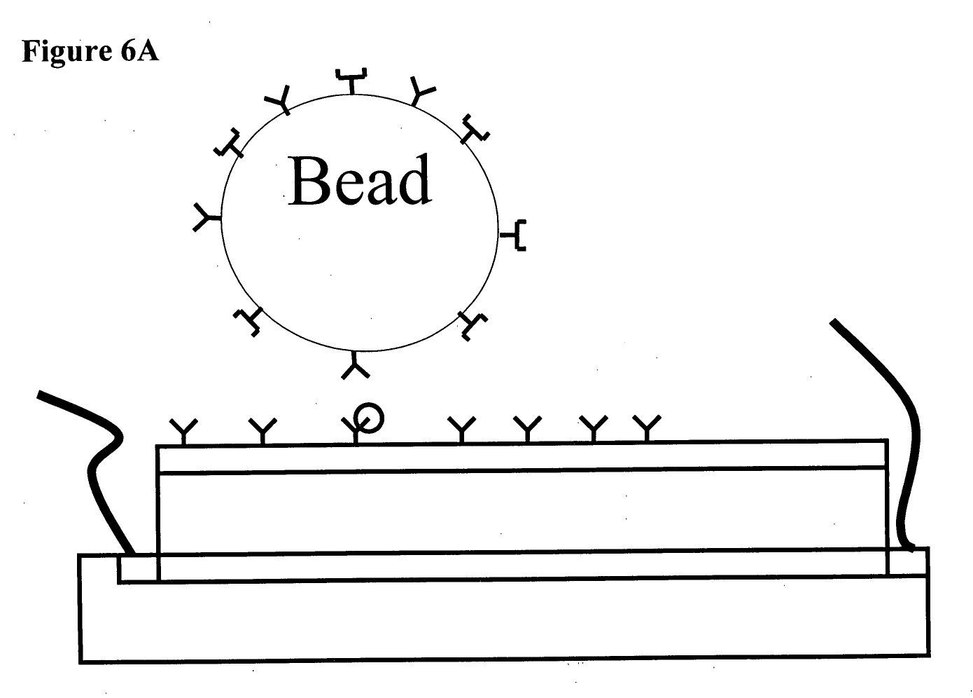

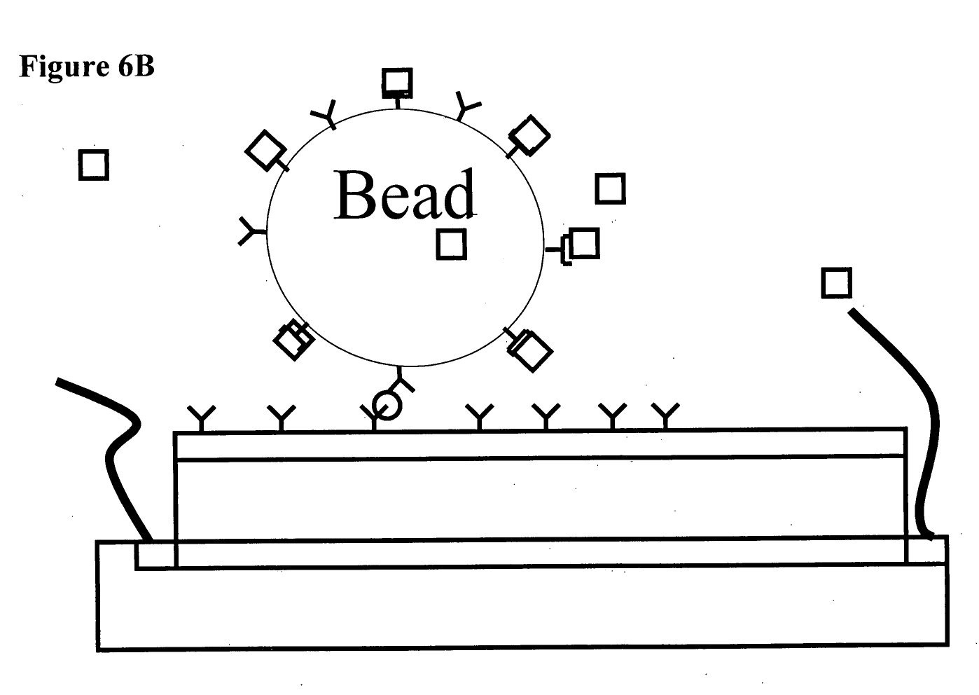

FIG. 6A shows still a different bead/chemical configuration. Attachment of the bead with the charged receptors adds overall charge to influence the sensor response. Additional processing or post processing with an antigen [symbol] specific to the additional receptor adds further charge and/or chemical potential. Additional post processing with [symbol] can further add to the charge influencing the underlying sensor. While an antibody example is displayed here, the chemicals involved may be antibodies, antigens, oligos, c-DNA, DNA, proteins or other chemicals.

An antibody (Y) is used, by way of example, to bind an antigen to the sensor's gate surface. An identical antibody is included in the mix of compounds attached to the bead and binds to the exposed antigen forming a sandwich. An additional second class of compounds is represented by the box square shaped receptor also attached to the bead. This later compound may be any other suitable chemical such as, for example, an antibody, DNA, c-DNA, RNA, an oligo, a protein or other chemical or chemical system specific binding system. The bead carries substantial additional charge already, but this can be increased as shown in FIG. 6B.

In FIG. 6B the sensor system is further exposed to a chemical constituency specific to the square receptor. FIG. 6B shows bead charge amplification means. A bead with attached chemicals, at least one of which is specific to the bound target molecule on the surface of the sensor, binds the bead to the sensor. A large number of specific antibodies (Y) enable the bead to carry a substantial charge. Thus, the original binding event signal is substantially amplified. A second set of receptors, e.g., other antibodies, or oligos, or DNA , or pre-selected proteins [symbol] are attached to the bead. Other charged chemicals [symbol] specific to the receptor [symbol] are then introduced to the system and bind to the receptor [symbol] thus supplying even more charge and thus further increasing the signal. This later set may be an antibody/antigen pair, some protein system or other chemical system. The latter pair may be attached to still another set of beads having substantial charged chemicals attached, thus cascading the system and related charges and sensor signal output.

By way of example, this could be another antigen specific to a (square) antibody, or could be a c-DNA specific to a (square) oligo, or a protein system, or other chemical specific pair system. In this way, exposure to the new chemicals, squares in FIG. 6B increases the sensing of the original target through further pre-selected specific chemical binding pairs (square receptor and square target). In this way, a large additional mount of protein, DNA, RNA, oligo, bead or other charge may be added to the gate selectively. The added charge only occurs if the original target binding occurs and occurs in proportion to the original bound target concentration.

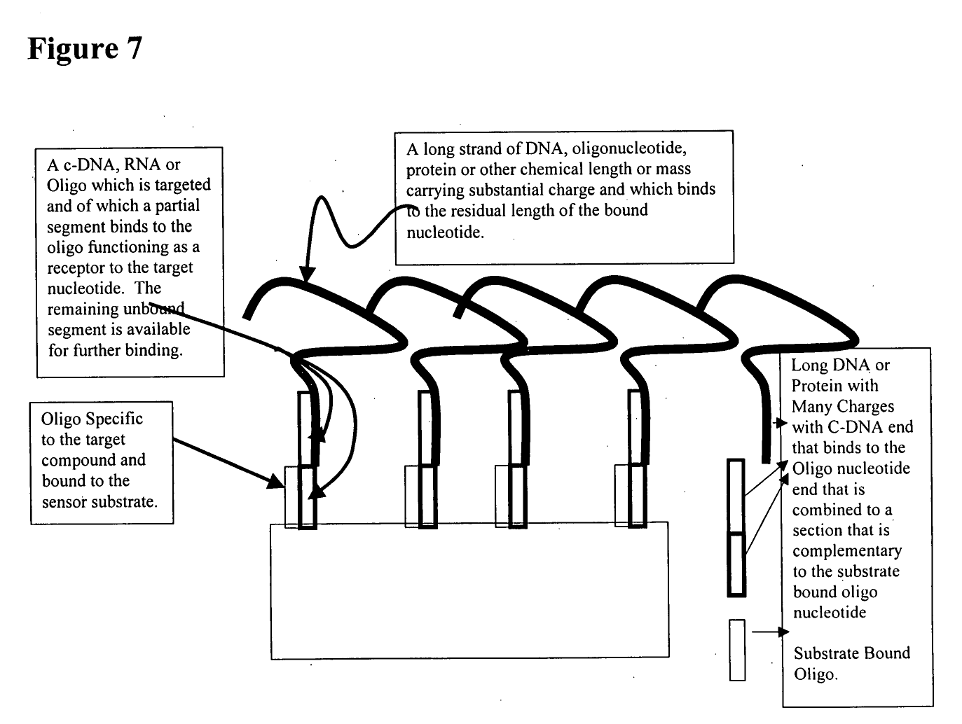

FIG. 7 shows a nucleotide charge amplifying system. A sequence of binding events results in a large, charge carrying chemical mass that is rich in net charge for attaching to a sensor substrate, and thus enhancing the signal for the original bound biochemical. The original oligo, which is already attached to a sensor gate, binds to a portion of a strand of, for example, c-DNA or RNA. The exposed unbound remainder of the bound target strand then binds selectively to still another strand that may, by way of example, be a long stand of c-DNA or RNA. In this way charge is added to the sensor gate only at those sites where there was the original target binding to the original gate-bound oligo receptor. The process may be compounded for further amplification. Other binding molecules may attach to the long strand, e.g., proteins to a DNA molecule. One achieves a compounded specificity and charge amplification with this system.

The attachment systems may be used to incorporate complementary targets that add confirmatory information or redundant information on the sensor target. The system may also be used for subsequent processing for other targets that may be present, with receptors or recognition elements to the additional target(s) provided on the attaching components. For example, an attaching bead may have additional receptors (recognition elements) for detecting subsequent cofactor or other target molecules. Confirmatory information provides increased confidence in the target identification.

The above are change amplification schemes that are presented by way of example. The invention in a more general form is represented in FIGS. 1 and 2.

It is also noted that the resistive, i.e. conductive, region C of FIG. 1 may be only some part of a sensor. Examples include FETS such as JFETS, MOSFETS, nanotube systems, BJTS, SCRS and thyristors, DCBDs, MESFETs, and other devices. The preferred embodiments include the conductive region C of FIG. 1 into a semiconductor device that is compatible with integrated circuit technologies, thereby enabling integrated electronic circuitry that provide useful information management functions.

Cascading of bead binding may be achieved to further increase charge amplification.

It is noted that some beads may carry net charged and these may be used in the invention, or may be prepared to carry charge through coating, chemical treatment or other means.

DNA, Oligo and RNA charge amplification methods may be used. Nucleotide chemicals may be included in the charge sensing amplification as indicated above and in the attached figures.

Examples of attached charge systems are discussed above and include proteins, nucleotides, beads, antibodies, many biochemicals and charged particles, such as metal beads that have been charged.

Protein amplification methods are described. It is well known that proteins carry charge. Proteins and/or protein chains may be added to the charge amplifying components, such as to another protein, an antibody, a stand of RNA or DNA, or to a bead, by way of example, to provide charge increase at the gate region and on the component particles used in the invention.

Antibody-DNA charge amplification is discussed. Examples are in the figures and discussed above to show how antibodies may be incorporated into the gate charge amplifying schemes.

Rolling circle amplification, as discussed herein, may be used to increase the length of a nucleotide chain, and thus the amount of charge it is providing. The rolling circle DNA chain may be attached to antibodies or other particles.

Detergents can carry charge. Coating beads of surfaces or biochemicals with such detergents can thus add charge.

It is well known that pH affects the charge on biochemicals. The pH of the test solution may be changed to enhance charge and also to provide confirmatory information.

PCR enhancement is discussed. Where nucleotide chemicals are incorporated, PCR may be employed. PCR may be used to further increase the amount of pre-selected nucleotides that are selectively incorporated to further increase sensing sensitivity. Other nucleotide amplification means, such as strand displacement amplification may also be used. The invention disclosure extends to all such amplifying schemes to be embraced in the current invention.

Other methods of increasing the gate charge will become obvious to those of skill in the art on reading this disclosure or learning of the invention. And, these too are claimed as a part of the invention.

Applications of the sensors and the charge amplification schemes are extensive. By way of example, some of the applications and markets for the invention include: Proteomics, disease diagnostics (human, animal, plant), drug discovery, co-factors, confirmation testing, genetics, toxin arrays, spores, cancer, drug efficacy, blood banking, arrays incorporating addressing redundancy, confirmation and multiple targets, and others.

It is noted that some of the approaches described in this document may also be applied to chemical potential enhancement where the sensor is targeting a chemical potential of materials attached to the gate region. By way of example, selected metal beads may be employed.

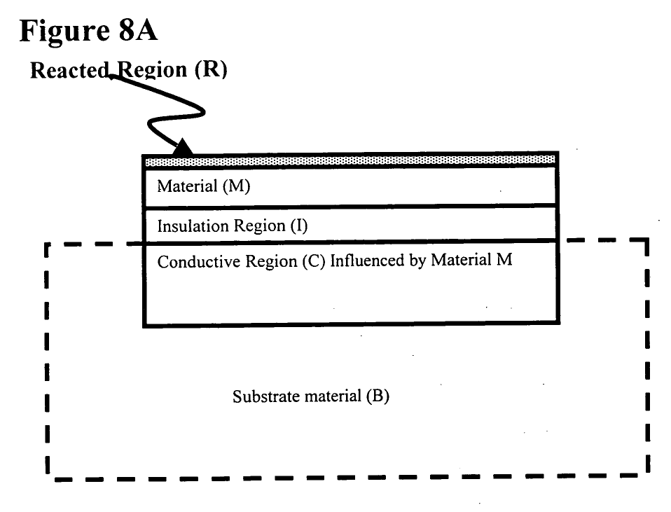

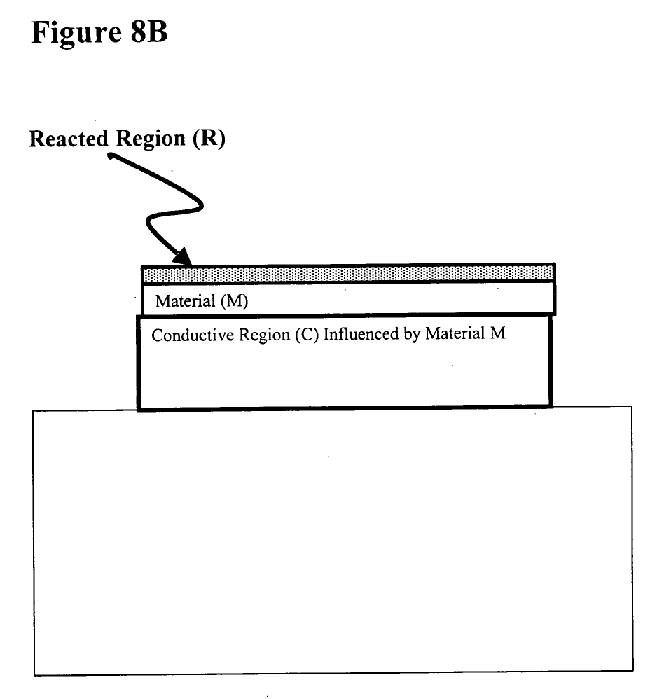

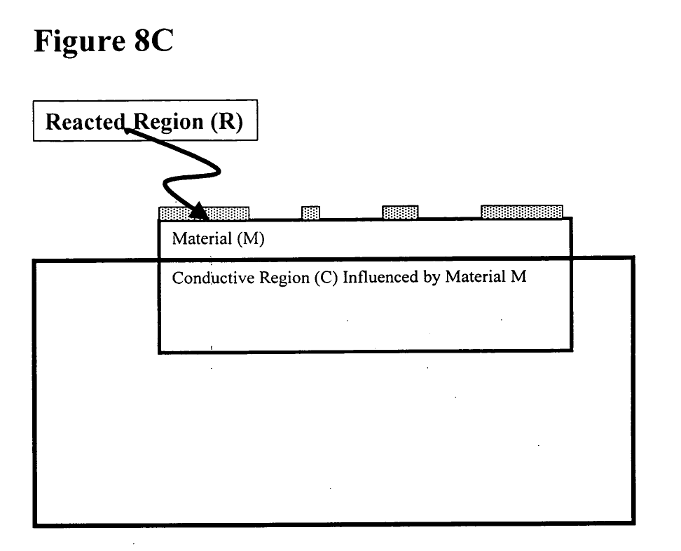

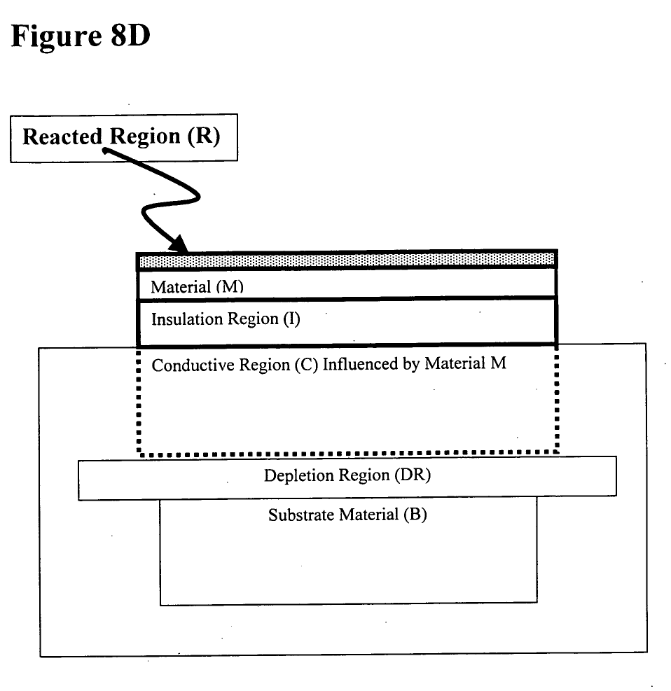

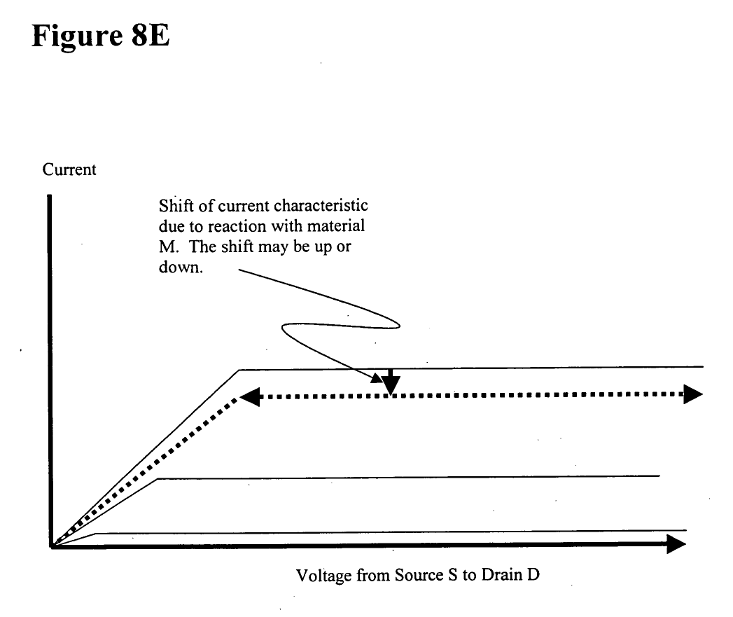

FIG. 8A shows a conducting region of, for example, silicon, as part of an underlying substrate S, also silicon in this example. An insulating region I separates the conductive region from a material M that coats the region I layer. A chemical reaction with material M forms a new material R that becomes the top coating of the sandwich. The top reactant material R then influences the underlying conductive region C.

FIG. 8B shows the material M reacting with a chemical to form a compound R. The reactant R becomes the top layer of the sandwich and influences the underlying contact between the conductive region C and the material region M. Thus the reactant R is detected.

FIG. 8C shows a system where the reaction of the chemical with material M causes only a partial coating of material M with the reactant material R. A MESFET like structure may be formed in analogy to the insulated gate FET structure of FIG. 8D. The shift of current characteristics is due to reaction with material M. The shift may be up or down.

FIG. 8D shows a semiconductor sensor example. Here the conductive structure is a part of a conducting channel in a semiconducting substrate, isolated from the bulk semiconductor (Si, in this example). A back bias may be applied to adjust the sensitivity of the device and to further affect conducting channel C electrical isolation.

FIG. 8E shows a current characteristic for the device of FIG. 8D. The reactant R, as illustrated in FIGS. 8A, B or C, influences the conduction of through the channel show in FIG. 8D.

While the invention has been described with reference to specific embodiments, modifications and variations of the invention may be constructed without departing from the scope of the invention, which is defined in the following claims.

1. An ultra sensitive sensor apparatus comprising:
a substrate,
an attachment material forming a gate on the substrate,
a conductive region in the substrate influenced by the attachment material,
receptors specific to target molecules on the attachment material,
target molecules attached to the receptors on the attachment material,
charge enhancers connected to the target molecule,
contacts connected to the substrate at opposite portions of the conductive region, and
a voltage source and conductors connected to the conductive region.

2. The apparatus of claim 1, wherein a surface portion of the substrate is preliminarily coated with an insulation region, and wherein the insulation region is coated with the attached material.

3. The apparatus of claim 1, wherein the charge amplifiers comprise nanotubes.

4. The apparatus of claim 1, wherein the charge amplifiers comprise nanoparticles.

5. The apparatus of claim 1, wherein the charge amplifiers comprise antibody probes.

6. The apparatus of claim 1, wherein the charge amplifiers comprise magnetic microparticle probes.

7. The apparatus of claim 1, wherein the charge amplifiers comprise DNA strands.

8. The apparatus of claim 1, wherein the charge amplifiers comprise RNA strands.

9. The apparatus of claim 1, wherein the charge amplifiers comprise a sandwich of captured target proteins with attached nanoparticle probes.

10. An ultra sensitive sensor apparatus comprising:
a substrate,
an insulation region coating a surface portion of the substrate,
an attachment material coating the insulation region and forming a gate on the substrate,
a conductive region in the substrate influenced by the attachment material,
receptors specific to target molecules on the attachment material,
target molecules attached to the receptors on the attachment material,
charge enhancers connected to the target molecule,
contacts connected to the substrate at opposite portions of the conductive region,
a voltage source and conductors connected to the conductive region, and
wherein the charge amplifiers comprise amplifiers selected from the group consisting of nanotubes, nanoparticles, antibody probes, magnetic microparticle probes, DNA strands, RNA strands, a sandwich of captured target proteins with attached nanoparticle probes, and combinations thereof.

11. An ultra sensitive sensing method comprising:
providing a substrate,
coating a surface portion of the substrate material with an attachment material,
creating a conductive region in the substrate,
influencing the substrate with the attachment material,
creating a conductive region in the substrate with the attachment material,
attaching charge enhancers to target molecules,
providing contacts on the substrate in contact with the conductive region,
connecting conductors to the contacts,
providing a potential between the conductors,
holding chemicals from an environment or solution on the charge enhancers, and
influencing current through the conductive region with the chemicals held on the charge enhancers.

12. The method of claim 11, further comprising providing an insulation region between the surface portion of the substrate and the attachment material.

13. The method of claim 11, wherein the attaching comprises maintaining charge enhancers on the target molecules and attaching the target molecules to the receptors.

14. The method of claim 13, further comprising connecting the target molecules to the receptors.

15. An ultra sensitive sensing method comprising:
providing a sensor with a substrate,
providing a conductive region in the substrate providing a gate region on the conductive,
providing an attachment material in the gate region,
providing receptors on the gate region,
exposing an environment or solution containing minute amounts of target chemicals to the receptors,
holding the target chemicals on the sensors,
creating charge enhancers as multiple charge carriers with binders to the target chemicals,
suspending the charge enhancers,
attaching the charge enhancers to the target chemicals held on the receptors, and
influencing conduction in the conductive region with the multiple charges carried by the charge carriers attached to the target chemicals held on the receptors on the gate region.
